(19) United States
(12) Patent Application Publication
(10) Pub. No.: US 2002/0031623 A1
(43) Pub. Date: Mar. 14, 2002

(54) METHOD FOR FORMING THIN FILM FOR LIQUID CRYSTAL DISPLAY

(76) Inventors: YUICHI MASAKI, KAWASAKI-SHI (JP); MASAAKI SUZUKI, YOKOHAMA-SHI (JP); TOSHIFUMI YOSHIOKA, HADANO-SHI (JP)

Correspondence Address: FITZPATRICK CELLA HARPER & SCINTO, 30 ROCKEFELLER PLAZA, NEW YORK, NY, 10112, US

(21) Appl. No.: 08/320,830

(22) Filed: Oct. 7, 1994

Related U.S. Application Data
(63) Continuation of application No. 07/956,975, filed on Oct. 6, 1992.

(30) Foreign Application Priority Data
Oct. 7, 1991 (JP) 285434/1991

(51) Int. Cl. C09K 19/00; B05D 3/12

(52) U.S. Cl. 428/1.25; 427/240; 427/168; 427/58

(57) ABSTRACT

A drawdown table rotatable at high speed is provided to spread ink mixed with no foreign matter so that a thin film of ink is printed with high accuracy. The ink is discharged from an ink feeding unit to the surface of the drawdown table, and uniformly spread in a non-contact manner on the entire surface of the table so that it has a predetermined thickness. A relief having a pattern to be formed is attached to either the drawdown table or a plate cylinder to be pressed to contact the drawdown table after the ink has been spread.

### BACKGROUND OF THE INVENTION

1. Field of the Invention

The present invention relates to a method of forming a thin film whereby a thin film, such as an orientational film of a liquid crystal display element, and an insulating film of a semiconductor element are printed and formed on a printing member, such as a glass or semiconductor substrate, and to a thin-film forming apparatus used for such a method.

2. Description of the Related Art

Methods of forming thin films are disclosed in Japanese Examined Patent Publication No. 61-39913, Japanese Unexamined Patent Publication No. 62-202736, Japanese Unexamined Utility Model Publication No. 58-170864, etc. In these methods, a low-viscosity solution (hereinafter referred to as ink) is used to print an orientational film of liquid crystal on a glass plate. Ink is spread on an offset proof press, or an intaglio or an intaglio roll, transferred to the surface of a relief corresponding to the shape of a printing pattern, and then pressed to contact the surface of a printing member, thereby forming a thin film.

When the low-viscosity ink is spread in accordance with the above-described known methods, the ink is discharged to an end of a drawdown plate formed of metal having fine recesses over the entire surface thereof. The ink is then scraped by a spatula called a doctor, made of metal or a high-molecular weight material, and while contact pressure is being applied, the ink is fed into the recesses. As a result, because of friction between the doctor and the recesses in the drawdown plate, part of the doctor or the drawdown plate is damaged. Thus, for example, when a liquid crystal display panel is manufactured, ink mixed with broken pieces of the doctor or drawdown plate is printed on a glass substrate, thereby forming a thin film having a substrate mixed with foreign matter. When such a substrate is formed into a panel, shortcircuiting occurs between the upper and lower electrodes, and there is an uneven gap between the upper and lower substrates.

### SUMMARY OF THE INVENTION

An object of the present invention is to solve the above problems.

Another object of this invention is to provide a thin-film forming method and apparatus capable of spreading ink with no foreign matter mixed and printing a thin film of ink onto a printing member with high accuracy.

A further object of this invention is to provide a thin-film forming method and apparatus in which low-viscosity ink is spread by a rotary motion on a drawdown table in a non-contact manner, and thus a film of ink having a uniform or substantially uniform thickness is formed on the drawdown table.

Still another object is to provide a thin-film forming method and apparatus in which a film of ink in the desired shape with a uniform thickness can be printed using such ink on a printing member, and in which a thin film mixed with no foreign matter is formed on the surface of a rigid body, such as glass.

Still another object is to provide a thin-film forming method and apparatus capable of controlling a film thickness by merely changing rotary conditions instead of by replacing a component of the apparatus as has to be done in the conventional methods.

Still another object is to provide a thin-film forming apparatus and method for forming an orientational film of a liquid crystal display element.

According to one aspect, the present invention relates to a thin-film forming apparatus comprising a drawdown table for spreading ink by rotating the drawdown table at a high speed so that the ink discharged from an ink feeding unit has a predetermined thickness; a plate cylinder provided with a relief having a thin-film pattern to be formed; a moving means to move said plate cylinder to the drawdown table; a stage for supporting a printing member wherein said moving means moves said plate cylinder to the printing member; and driving means for first pressing the plate cylinder against the drawdown table so that the ink can be transferred to a surface of the relief of the plate cylinder, and then for pressing the plate cylinder against a surface of the printing member so that a thin-film pattern on the relief can be transferred to the surface of the printing member.

According to another aspect, this invention relates to a thin-film forming apparatus comprising a drawdown table provided with a relief on a surface thereof, the relief having a thin-film pattern to be formed; means for discharging a predetermined amount of ink to the center of the relief on the surface of the drawdown table; means for rotating the drawdown table at a high speed so that the ink can be spread on the relief; a stage for supporting a printing member; and means for pressing the relief against the printing member so that the ink spread on the relief can be transferred to the printing member.

According to still another aspect, this invention relates to a thin-film forming method comprising the steps of supplying ink to a drawdown table having a flat portion on a surface thereof; forming a uniform or substantially uniform ink layer on the flat portion by rotating the drawdown table to which the ink has been supplied; and transferring the ink layer to a transfer surface upon which relief pattern is formed.

According to another aspect, this invention relates to a thin-film forming apparatus for forming a thin-film pattern on a substrate of a display element using a liquid crystal comprising a base; a drawdown table on said base for spreading ink at a predetermined thickness by means for rotating said drawdown table; an ink feeding unit on said base for discharging ink to said drawdown table; a plate cylinder on said base provided with a relief having a thin-film pattern and means to move said plate cylinder to said drawdown table; driving means for pressing said plate cylinder against said drawdown table to transfer the ink to a surface of the relief; a means to move said plate cylinder to said substrate, wherein said driving means presses said plate cylinder against a surface of said substrate so that the thin-film pattern on relief is transferred to said substrate.

In a further aspect, this invention relates to a thin-film forming method comprising the steps of supplying ink to a drawdown table having a flat portion on a surface thereof; forming a substantially uniform ink layer by rotating the drawdown table to which the ink has been supplied; said drawdown table moving to a rotary position where it is rotateed to spread the ink and moving to a transfer position to transfer the ink to a plate cylinder having a relief pattern; pressing said plate cylinder against the drawdown table; moving said plate cylinder to a printing member and transferring the ink to said printingmember by pressing said relief against said printing member.

In a further aspect, this invention relates to a thin-film forming method comprising the steps of supplying ink to a drawdown table having a flat portion on a surface thereof; wherein the shape of said flat portion is substantially the same as that of the desired pattern to be found on the printing member, forming a substantially uniform ink layer by rotating the drawdown table; transferring said ink layer to a printing member by pressing said pattern against said printing member.

In another aspect, this invention relates to a thin-film forming method in a liquid crystal device comprising the steps of supplying ink to a drawdown table having a flat portion on a surface thereof; forming a substantially uniform ink layer by rotating the drawdown table to which the ink has been supplied; transferring said ink from the drawdown table to a plate cylinder with a relief having electrode patterns by pressing said cylinder plate against the drawdown table; moving said plate cylinder to a printing member having supporting members transferring said electrode patterns to said supporting members; and inserting a ferroelectric liquid crystal.

### BRIEF DESCRIPTION OF THE DRAWINGS

FIG. 1 is a schematic view illustrating the outline of a thin-film forming apparatus according to an embodiment of the present invention;

FIG. 2 is a graph showing the relationship between the film thickness and rotary conditions for a drawdown table;

FIG. 3(A) is a schematic plan view showing a drawdown table having recesses according to another embodiment of this invention;

FIG. 3(B) is a sectional view taken along line A-A′ of FIG. 3(A);

FIG. 4 is a schematic view illustrating the concept of a thin-film forming apparatus according to a further embodiment of this invention; and

FIG. 5 is a sectional view illustrating an embodiment of a liquid crystal display device manufactured by the thin-film forming method of this invention.

### DESCRIPTION OF THE PREFERRED EMBODIMENTS

The preferred embodiments of the present invention will be described below in detail.

The outline of a thin-film forming apparatus of this invention will be described with reference to FIG. 1, which is a view schematically showing the basic structure of the apparatus. A drawdown table or stage 1 is made of metal, glass, a high-molecular weight material or the like having a flat obverse surface thereof. The drawdown table 1 has an area wider than that of a pattern to be formed, and the shape of a polygon, a circle, or preferably, a disk so that the drawdown table 1 can be rotated smoothly as will be described later. The drawdown table 1 is capable of moving up and down. When it is in a lower position indicated by broken lines, an ink feeding unit 2 moves in a direction indicated by arrow a and broken lines, and then discharges a fixed amount of ink from a pressure tank 3 to the center of the drawdown table 1. The drawdown table 1 is supported by a shaft 10 and rotated by a motor 5.

Numeral 6 denotes a plate cylinder. A relief 7 is placed on the outer periphery of the plate cylinder 6. The plate cylinder 6 on which the relief 7 is placed is capable of moving in a direction indicated by arrow c. Numeral 8 denotes a printing member mounted on a stage 9.

In operation, when the plate cylinder 6 is placed in position A1 shown in FIG. 1, a fixed amount of ink is supplied to the drawdown table 1 as mentioned previously. It is preferable that ink having a low-viscosity ranging from several to 200 cp be used. A mixture of a solvent and resin or a resin precursor is an example of the ink used in this invention.

After the ink has been fed to the drawdown table 1, the ink feeding unit 2 slides back in a direction indicated by arrow a to the position shown by solid lines, thus moving outside a spin cup 4. The motor 5 spins the drawdown table 1 a preset number of revolutions for a preset amount of time, whereby the ink discharged is spread uniformly on the surface of the table 1. The drawdown table 1 ascends in a direction indicated by arrow b to a predetermined position, where it is fixed.

While the plate cylinder 6 is moving from position A1 to position A2, the relief 7 on the plate cylinder 6 rotates while in contact with the surface of the drawdown table 1. The ink on the table 1 is thus transferred onto the surface of the relief 7.

The relief 7 has a pattern shape to be formed or a pattern shape that can be formed on the printing member 8. It is made of rubber, such as butyl rubber; resin, such as nylon resin; or a photosensitive material, such as a photosensitive rubber or resin.

In other words, a material capable of forming the desired pattern is selected and used for the relief 7 by considering the material of the printing member 8, the type and viscosity of the ink and properties of the ink for withstanding printing as well as other factors.

After the ink has been transferred from the drawdown table 1 to the surface of the relief 7, the plate cylinder 6 moves to position A3, where the stage 9 supports the printing member 8. While the relief 7 is being rotated, it is pressed to contact the printing member 8. As a result, the ink is transferred to the surface of the printing member 8 so as to form a thin film. A substance, such as glass, having a flat surface or a slightly uneven surface is suitable for the printing member 8.

However, the degree of the unevenness of surface of the printing member 8 on which a film can be printed varies according to certain factors, such as the mechanical properties of the materials of the plate cylinder 6 and the relief 7, pressure applied between the plate cylinder 6 and the printing member 8, printing speed or the speed at which the plate cylinder 6 rotates, and the viscosity and thickness of the ink.

As has been described above, this invention is capable of spreading ink in a non-contact manner at a predetermined thickness on the drawdown table. In other words, because of the provision of the drawdown table being rotatable at a high speed, ink supplied to the drawdown table can be spread at the predetermined thickness.

In addition, this invention makes it possible to form a thin film with no foreign matter mixed in, since there is no contact or friction between rigid bodies.

Methods of forming thin films will now be described.

### First Embodiment

Polyimide resin SP-710 manufactured by Toray Industries, Inc. and N-methyl pyrrolidone (NMP) are used to prepare a polyimide solution having a solid content of 4%. 30 cc of the polyimide solution is introduced into a disk-like drawdown table having a glass surface and a size of 300 mmφ. The drawdown table is spun under the condition where the number of revolutions of the table reaches 2000 rpm in two seconds, and then the table is stopped for two seconds so as to uniformly spread the polyimide solution. A plate cylinder is moved at a speed of 200 mm/second under the condition where the amount the plate cylinder is pressed against the drawdown table and a printing member is set at 0.2 mm. The plate cylinder has a 150 mm×200 mm relief, made of photosensitive rubber (APR manufactured by Asahi Chemical Industry Co., Ltd.), having a coarseness of 250 lines on the surface thereof. The solution, that is, the ink is transferred from the drawdown table to the relief, and then from the relief to a 300×300 mm glass plate, which is a printing member, having a thickness of 1.1 mm. The ink is then printed on the glass plate. The thus-printed glass is calcined in an oven at 300° C. for 1 hour. Thereafter, when the thickness of a film of ink is measured by a feeler-type thickness meter (DEKTAK manufactured by Napson Company). The film thickness at 10 sampling points within a plane are found to be extremely uniform, ranging from 490 to 510 Å.

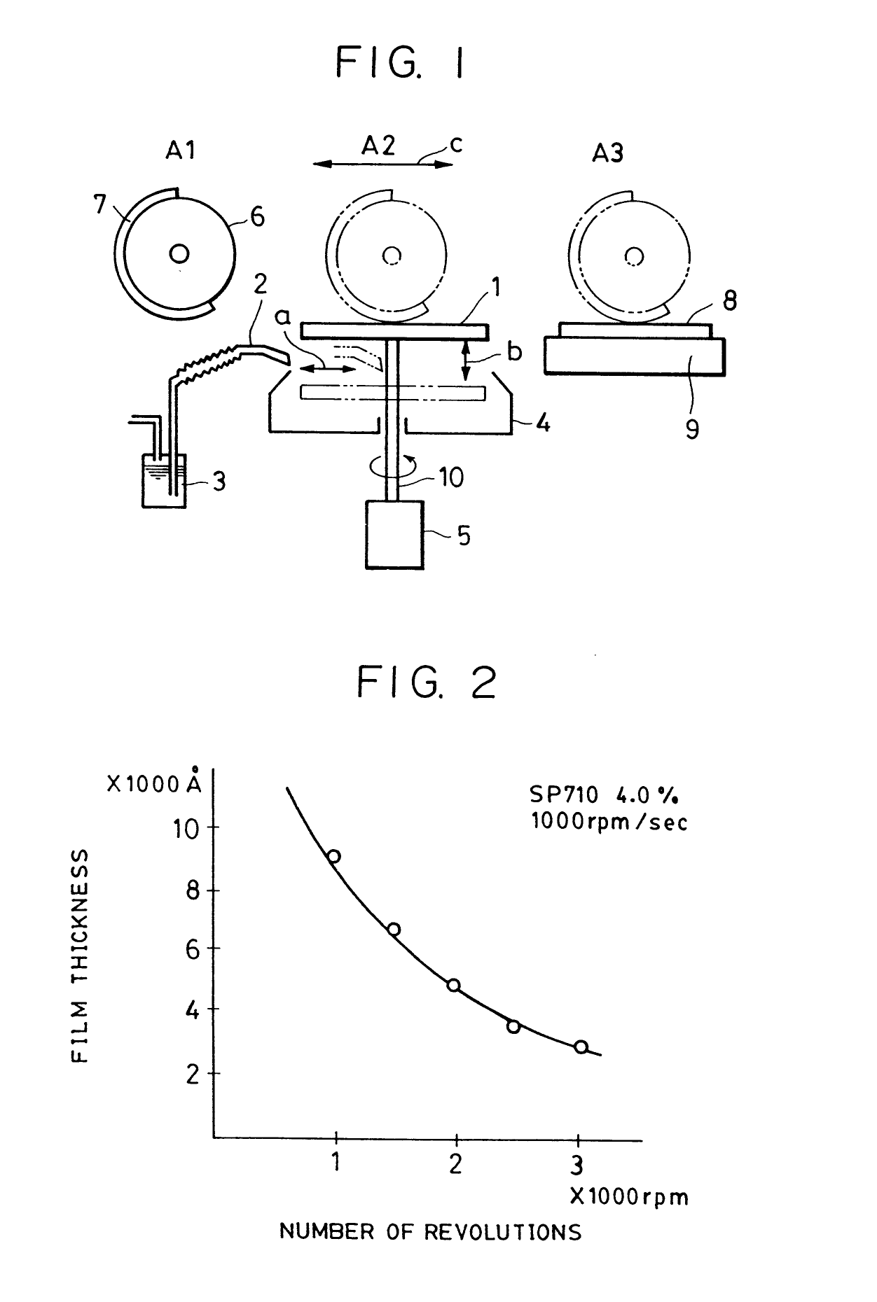

The thickness of the thin film can be controlled by changing rotary conditions for the drawdown table. FIG. 2 shows the relationship between the film thickness and the rotary conditions for the drawdown table.

As can be seen from FIG. 2, unless the properties of the ink change, the thickness of a thin film formed on the drawdown table decreases as the number of revolutions of the table increases.

The relationship between the film thickness and the number of revolutions varies according to the ambient temperature, the viscosity and the solid content of the ink, and other factors. However, even when these factors are considered, it is easy to control the film thickness, as it is not difficult to find the optimum conditions for obtaining the desired film thickness.

### Second Embodiment

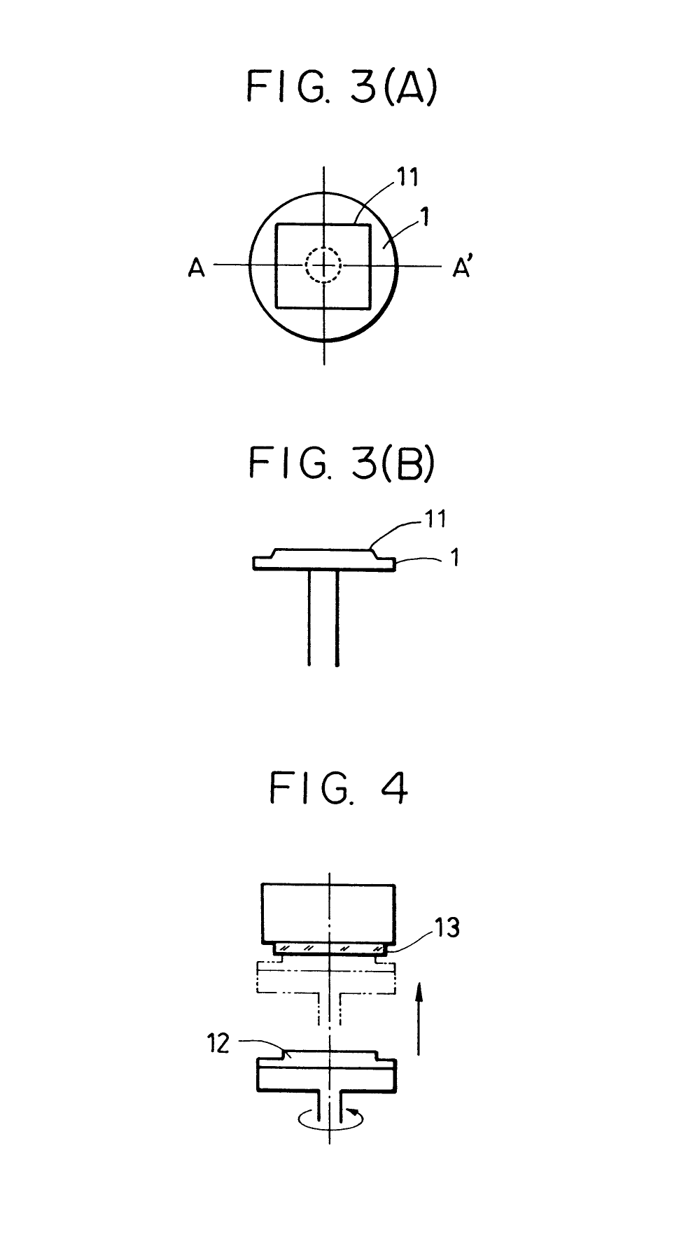

In this embodiment, a projection having the desired shape is formed on the surface of a drawdown table used for forming a thin film. More specifically, as shown in FIG. 3, a 150 mm×200 mm projection 11 formed of an aluminum plate and having a thickness of 1 mm is formed on a disk 1 having a flat surface and a size of 300 mmφ.

A polyimide solution is supplied to the drawdown table under the same conditions as those in the first embodiment. Then, the polyimide solution is spread on the drawdown table by rotating the table. A plate cylinder is moved at a speed of 200 mm/second under the condition where the amount the plate cylinder is pressed against the drawdown table and a printing member is set at 0.2 mm. The plate cylinder has a 250 mm×250 mm relief, made of photosensitive rubber, and having a coarseness of 250 lines on the surface thereof. A thin film having the same area and shape as the projection 11 on the drawdown table can be printed on a glass plate, which is a printing member.

### Third Embodiment

As shown in FIG. 4, a 150 mm×200 mm relief 12, made of photosensitive rubber, having a coarseness of 250 lines of the surface thereof is attached to the surface of the drawdown table. The polyimide solution is supplied to the surface of the drawdown table under the same conditions as those in the first embodiment. Then, the drawdown table is spun to spread the polyimide solution so that it has a uniform thickness. The relief 12 is then directly pressed, using a pressure of 20 g/cm², to contact a vacuum-chucked glass plate 13 for 1 second. As a result, in the same manner as in the above-described embodiments, a thin film can be printed uniformly on the glass plate.

### Fourth Embodiment

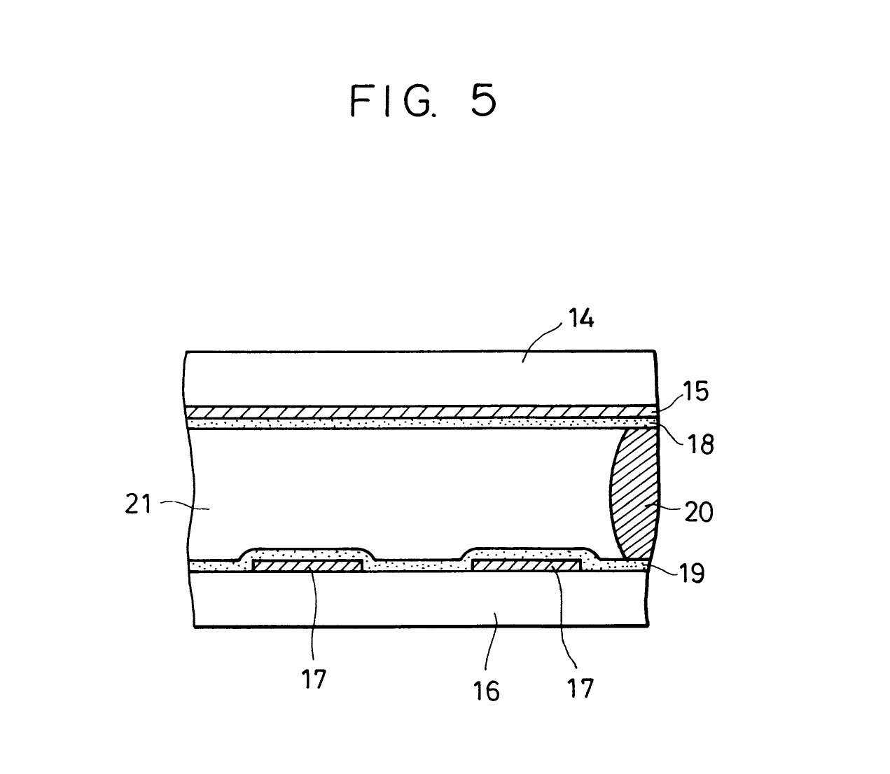

An embodiment of a liquid crystal display device will now be described. FIG. 5 is a schematic view of the liquid crystal display device. In this embodiment, the thin-film forming method of this invention is applied so as to form an orientational film in the liquid crystal display device.

The same polyimide film as in the first embodiment is formed on glass substrates 14 and 16, which are supporting members. Electrode patterns 15 and 17 formed by the thinfilm forming method described in the first embodiment are respectively formed on the glass substrates 14 and 16. The thickness of the polyimide film is the same as in the first embodiment, that is, in a range from 490 to 510 Å.

The surface of the polyimide film is subjected to a rubbing treatment to form orientational films 18 and 19.

When a liquid crystal panel thus formed is manufactured with the aid of a 1.5 μ spacer 20, a cell can be obtained which has a uniform gap instead of an uneven gap due to foreign matter being mixed in the film.

A ferroelectric liquid crystal 21 is inserted into the cell, thus completing the liquid crystal display device. When the display device is operated, the polyimide film which has been formed exhibits excellent orientational characteristics. It is thus possible for the device to perform displaying because of the uniform thickness of the film and the uniform size of the gap between the cells.

As has been described above, in this invention, a rotary motion permits a low-viscosity ink to be spread on a drawdown table in a non-contact manner, thereby forming a film of ink having a uniform or substantially uniform thickness on the table. The film can be printed in the desired shape on a printing member using such ink. In addition, a thin film with no foreign matter mixed in can be formed on the surface of a rigid body, such as glass. Furthermore, the thickness of the film can be controlled by merely changing rotary conditions instead of by replacing a component of the apparatus as has to be done in the conventional methods.

The thin-film forming method and apparatus of this invention are not limited to the method and apparatus described herein, and may be modified within the scope of the claims of this invention. The shape of the liquid crystal display unit described in the fourth embodiment is not limited to the shape described herein. Furthermore, this invention may also be applied to form, in addition to an orientational film in a liquid crystal display device using a ferroelectric liquid crystal, an orientational film in an active-matrix type liquid crystal display device and a liquid crystal display device using a twisted nematic liquid crystal. The thin-film forming method of this invention is effectively used for forming a thin film in liquid crystal display devices, particularly those using a ferroelectric liquid crystal in which a small and accurate gap must be formed between the cells.

The scope of the following claims is to be accorded the broadest interpretation so as to encompass all such modifications and equivalent structures and functions.

What is claimed is:

1. A thin-film forming apparatus comprising:
a base;
a drawdown table on said base for spreading ink having a predetermined thickness;
means for rotating said drawdown table;
an ink feeding unit on said base for applying ink to said drawdown table to spread said ink when said ink is applied to said drawdown table;
a plate cylinder provided with a relief having a surface and having a thin film pattern on said base;
means to move said plate cylinder to said drawdown table;
a driving means for pressing said plate cylinder against said drawdown table to transfer the ink to a surface of the relief;
a printing member on said base, having a surface and a stage for supporting said printing member;
said means to move said plate cylinder to said printing member wherein said driving means presses said plate cylinder against a surface of the printing member so that the thin-film pattern on the surface of the relief is transferred to the surface of the printing member.

2. A thin-film forming apparatus according to claim 1 for forming a thin-film pattern on a substrate of a display element using a liquid crystal.

3. A thin-film forming apparatus according to claim 2, wherein said liquid crystal is a ferroelectric liquid crystal.

4. A thin-film forming apparatus according to claim 1, wherein said drawdown table moves between a rotary position and a transfer position.

5. A thin-film forming apparatus according to claim 1, wherein the ink feeding unit moves between an ink feeding position and a retracted position.

6. A thin-film forming apparatus according to claim 1, wherein the ink is a polyimide solution.

7. A thin-film forming apparatus according to claim 1, wherein the viscosity of the ink is not more than 200 cp.

8. A thin-film forming apparatus according to claim 1, wherein the surface of the relief is coarse, having a coarsness of 250 lines.

9. A thin-film forming apparatus according to claim 1, wherein a projection having a pattern corresponding to the relief is formed on said drawdown table.

10. A thin-film forming apparatus according to claim 1, wherein the printing member has a supporting member and an electrode pattern.

11. A thin-film forming apparatus comprising:
a base;
a drawdown table on said base having a relief on a surface thereof, said relief having a center, and a thin-film pattern thereon to be formed on a surface of a printed member;
discharge means for discharging a predetermined amount of ink to the center of said relief on the surface of said drawdown table;
rotating means for rotating said drawdown table with a speed which causes the ink to be spread on said relief;
a stage for supporting a printing member and a stage for supporting said printing member, on said base; and
means for pressing said relief against the printing member so that the ink spread on said relief is transferred to the printing member.

12. A thin-film forming apparatus according to claim 11 for forming a thin-film pattern on a substrate of a display element using a liquid crystal.

13. A thin-film forming apparatus according to claim 12, wherein said liquid crystal is a ferroelectric liquid crystal.

14. A thin-film forming apparatus according to claim 11, wherein said drawdown table moves between a rotary position and a transfer position.

15. A thin-film forming apparatus according to claim 11, wherein the means for discharging ink is capable of moving to an ink feeding position and a retreat position.

16. A thin-film apparatus according to claim 11, wherein the ink is a polyimide solution.

17. A thin-film forming apparatus according to claim 11, wherein the viscosity of the ink is not more than 200 cp.

18. A thin-film forming apparatus according to claim 11, wherein the surface of the relief is coarse, having a coarsness of 250 lines.

19. A thin-film forming apparatus according to claim 11, wherein a projection having a pattern corresponding to the relief is formed on said drawdown table.

20. A thin-film forming apparatus according to claim 1, wherein the printing member has a supporting member and an electrode pattern.

21. A thin-film forming method comprising the steps of:
supplying the ink to a drawdown table having a flat portion on a surface thereof;
rotating said drawdown table to which the ink has been supplied to form a substantially uniform ink layer on said flat portion;
providing a transfer surface; and
transferring the ink layer to said transfer surface.

22. A thin-film forming method according to claim 21, wherein said transfer surface is a plate provided on a rotatable plate cylinder.

23. A thin-film forming method according to claim 22, wherein said plate is a relief.

24. A thin-film forming method according to claim 22, wherein said ink layer is transferred initially to said plate and then to a printing member.

25. A thin-film forming method according to claim 21, wherein said ink layer is transferred to the printing member.

26. A thin-film forming method according to claim 21, wherein the shape of said flat portion is substantially the same as that of a desired pattern to be formed on the printing member.

27. A thin-film forming method according to claim 25, wherein said ink layer formed on said flat portion is transferred to the printing member.

28. A thin-film forming method according to claim 26, wherein said ink layer is transferred to the printing member from said plate.

29. A thin-film forming method according to claim 27, wherein said plate is provided on the rotatable plate cylinder.

30. A thin-film forming method according to claim 21 for forming a thin-film pattern on a substrate of a display element using a liquid crystal.

31. A thin-film forming method according to claim 29, wherein said liquid crystal is a ferroelectric liquid crystal.

32. A thin-film forming method according to claim 21, wherein said drawdown table is capable of moving between a rotary position where it is rotated and a transfer position where the ink is transferred.

33. A thin-film forming method according to claim 21, wherein the ink is supplied by an ink feeding unit.

34. A thin-film forming method according to claim 21, wherein at least a part of the ink feeding unit is moved to an ink feeding position so as to supply the ink and is in a retreat position when the ink is not supplied.

35. A thin-film forming method according to claim 21, wherein the ink is a polyimide solution.

36. A thin-film forming method according to claim 21, wherein the viscosity of the ink is not more than 200 cp.

37. A thin-film forming method according to claim 23, wherein a projection having a pattern corresponding to the surface of the relief is coarse, having a coarseness of 250 lines.

38. A thin-film forming method according to claim 23, wherein a projection having a pattern corresponding to the relief is formed on said drawdown table.

39. A thin-film forming method according to claim 26, wherein the printing member has a supporting member and an electrode pattern.
